(19) United States
(12) Patent Application Publication
(10) Pub. No.: US 2006/0244279 A1
(43) Pub. Date: Nov. 2, 2006

(54) Cargo management system and method

(75) Inventors: Noel V. Ranka, Canton, MI (US); Donald R. Potter, Clarkston, MI (US); Gerard J. Kmita, Allen Park, MI (US); Jeffrey M. Aftanas, Ortonville, MI (US)

Correspondence Address: HARNESS, DICKEY & PIERCE, P.L.C., P.O. BOX 828, BLOOMFIELD HILLS, MI, 48303, US

(73) Assignee: JAC Products, Inc.

(21) Appl. No.: 11/415,456

(22) Filed: May 1, 2006

Related U.S. Application Data
(60) Provisional application No. 60/676,906, filed on May 2, 2005.

(51) Int. Cl. B60R 9/00

(52) U.S. Cl. 296/37.6

(57) ABSTRACT

A cargo management system for use in the bed of a pickup truck. The system includes a pair of side rails that are mounted on inside wall portions of the side walls of the pickup truck bed. A central frame portion is provided and is secured at its opposite longitudinal ends to a pair of auxiliary cargo containers. The central frame portion can receive either a rigid storage tray or a soft, collapsible, drop-in storage bag. The central frame portion can also be folded down generally flush against a forward end wall of the truck bed. The entire assembly of the central frame portion and the pair of auxiliary cargo containers can be moved slidably along the side rails and positioned within the truck bed as needed. The central frame portion and the pair of auxiliary cargo containers can thus be used to hold items, and the entire assembly can be used as a bulkhead within the truck bed to restrain other larger articles.

### RELATED APPLICATIONS

This application claims priority from U.S. provisional patent application Ser. No. 60/676,906, filed May 2, 2005, the disclosure of which is hereby incorporated by reference.

### FIELD

The present disclosure relates to cargo systems used with motor vehicles, and more particularly to a cargo management system for use in the bed of a motor vehicle, for example the bed of a pickup truck.

### BACKGROUND

Cargo management systems used with motor vehicles, and particularly with pickup trucks, are becoming more and more desirable, as pickup trucks gain in popularity.

In an effort to further increase the utility of the bed of the vehicle, various devices for partitioning the bed have been developed. However, such systems often cannot be quickly and easily removed from the bed and/or use a sizable portion of the bed when in use. Such existing systems are often not easily movable within the bed; thus, they occasionally interfere with the positioning of larger items within the bed.

Accordingly, there still remains a need for a cargo management system that provides a means for containing articles such as groceries and other items, and that still can be placed in a storage configuration within the bed. The ability to place the system in a storage configuration would help to make the great majority of the bed available for use for carrying larger items. It would also be highly desirable if such an apparatus could be re-positioned within the bed as needed, and moved between its operable and stowed positions, without complicated or burdensome disassembly operations, and without requiring removal of all or part of the apparatus from the pickup bed. There also remains a need for such a cargo management system that can be moved and adjustably positioned within the bed of a pickup truck to act as a bulkhead to effectively partition the bed and to assist in restraining larger items being carried in the bed.

### SUMMARY

The present disclosure relates to a cargo management system especially well adapted for use in a bed of a motor vehicle. In one implementation the system is especially well adapted for use in a pickup truck bed, although the system can be used in other applications where it would be desirable to partition a cargo area to further increase the utility of the cargo area.

In one form the cargo management system includes a central frame portion for supporting a cargo box, and a pair of auxiliary storage containers disposed at opposite ends of the central frame portion. The central frame portion and the pair of auxiliary storage containers are supported from parallel sidewalls of the pickup bed. The central frame portion is also pivotally secured to the auxiliary storage boxes so that it can be moved between a useable position generally coplanar with the upper edges of the sidewalls of the pickup bed, and a lowered position in which it rests generally flush against the end wall of the pickup bed. The central frame portion and the auxiliary storage containers are further supported along guide rails mounted on the inside wall portions of the side walls of the bed. The entire assembly of the central frame portion and the two auxiliary storage containers can be moved slidably as a single unit fore and aft in the truck bed, and secured at a desired position with manually engageable securing elements.

In one implementation the central frame portion receives a rigid cargo storage box. The cargo storage box can be dropped into the central frame portion and supported therefrom. In another implementation a soft cargo bag can be placed in the central frame assembly for holding items where ventilation for the items would be desired. The use of the soft cargo bag also enables the central frame portion to be pivoted down flush against the end wall without the need to first remove the soft cargo bag.

In one implementation both the central frame portion and the auxiliary storage containers each include an associated lid that can be opened independently of one another to provide access to only those areas of the system that require access.

In another implementation the entire assembly of the central frame portion and the pair of auxiliary storage containers are supported for sliding movement on a pair of side rails secured to the upper inside wall portions of the sidewalls of the pickup bed. Thus, the entire assembly can be moved slidably along the side rails positioned at a desired location in the pickup bed. This feature also enables the system to be used as a bulkhead to restrain other articles being transported in the bed, but which are too large to be held in the storage compartments of the system itself.

Further areas of applicability of the present disclosure will become apparent from the detailed description provided hereinafter. It should be understood that the detailed description and specific examples, while indicating the various embodiments, are intended for purposes of illustration only and are not intended to limit the scope of the present disclosure.

### BRIEF DESCRIPTION OF THE DRAWINGS

The present disclosure will become more fully understood from the detailed description and the accompanying drawings, wherein:

FIG. 1 is a perspective view of an embodiment of the cargo management system being used in a bed of a pickup truck;

FIG. 2 is a perspective view of the rigid cargo supporting tray, and the soft, collapsible, drop-in storage container, each of which can be used interchangeably with the central frame portion of the system;

FIG. 2A is a perspective view of the system of FIG. 1;

FIG. 3 is a perspective view of the system illustrating the central frame portion in its collapsed or “stowed” position;

FIG. 4 is a perspective view of just the side rail components of the system;

FIG. 4A is an end view of one of the side rail components shown in FIG. 4;

FIG. 5 is an end view of an alternative preferred side rail that incorporates a second C-shaped channel and a flange for assisting in securing a tonneau cover to the side rail to cover the truck bed;

FIG. 6 is a perspective view of the system with the central frame portion in its stowed position, and the system positioned adjacent a tailgate of the truck bed; and

FIG. 7 is a perspective view of the system positioned at two different positions within the truck bed, in its useable configuration.

FIG. 8 is a perspective view of a portion of the system of FIG. 1, better illustrating the release mechanism and the securing mechanism;

FIG. 9 is a partial side cross-sectional view of the frame portion taken along section line 9 in FIG. 8, illustrating several components of the release mechanism, and showing the release mechanism with a release lever thereof in a locked position;

FIG. 9a is a perspective view of the coupling element used with the release mechanism of FIG. 9;

FIG. 10 is a view of the release mechanism of FIG. 9 but with the release lever having been urged into an unlocked position;

FIG. 11 is a side view of a portion of the central frame portion in accordance with directional line 11 in FIG. 8, and illustrating more fully the release lever and a bushing used to support the frame portion in its usable and stowed configurations;

FIG. 12 is a side view of the auxiliary storage compartment illustrating the structure on an outer surface thereof that cooperates with the release mechanism to enable positioning of the frame portion in its operative and stowed positions, as well as several components of the release mechanism to help the reader understand the orientation of such components relative to the relevant structure on the auxiliary storage compartment;

FIG. 13 is a view of the components shown in FIG. 12 but with the components shown in the positions they assume after the release lever has been rotated to its fully unlocked position, but while the central frame portion would still be in its usable (i.e., not stowed) orientation;

FIG. 14 is a view of the components of FIGS. 12 and 13, but showing the orientations of the components after the central frame portion has been lowered into its stowed position;

FIG. 15 a side cross-sectional view in accordance with section line 15-15 in FIG. 8 illustrating the securing mechanism associated with one of the auxiliary storage compartments, with a locking lever of the mechanism positioned in its locked position such that the auxiliary storage compartment is fixedly secured against movement, relative to its associated side rail;

FIG. 16 is a view of the securing mechanism of FIG. 15 but with the locking lever moved into its unlocked position, thus enabling longitudinal movement of the central frame portion and auxiliary storage compartment along the side rail; and

FIG. 17 is a perspective view of the locking lever and a portion of the locking pin, illustrating the yoke formed in the locking lever.

### DETAILED DESCRIPTION

The following description of the various embodiments is merely exemplary in nature and is in no way intended to limit the present disclosure, its application, or its uses.

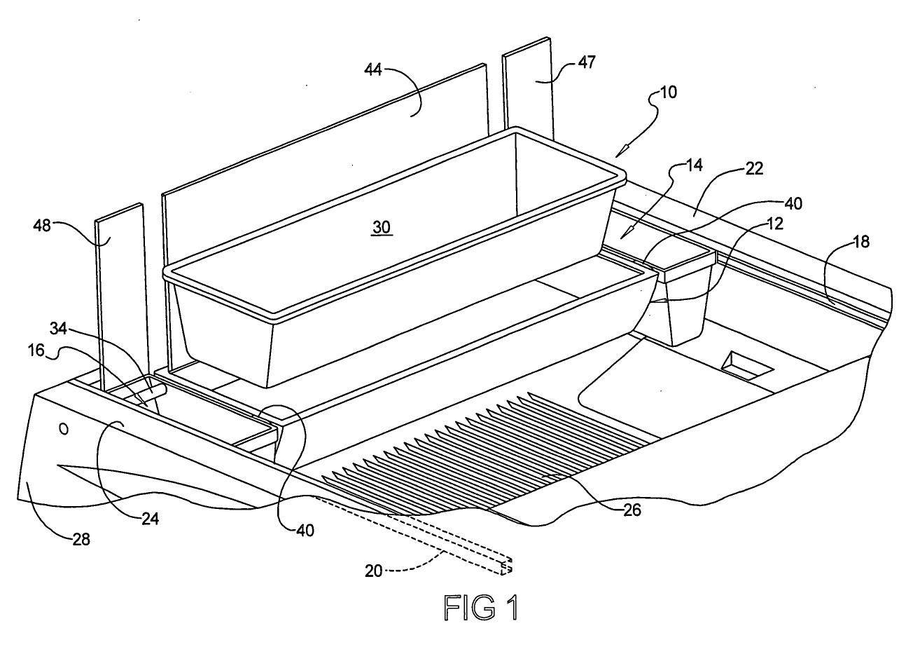

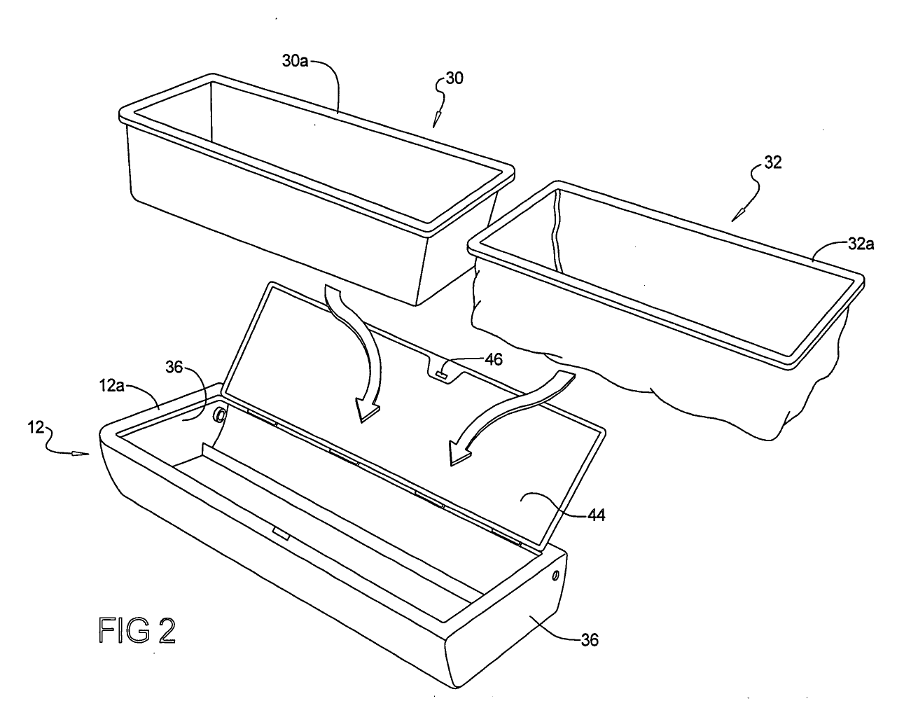

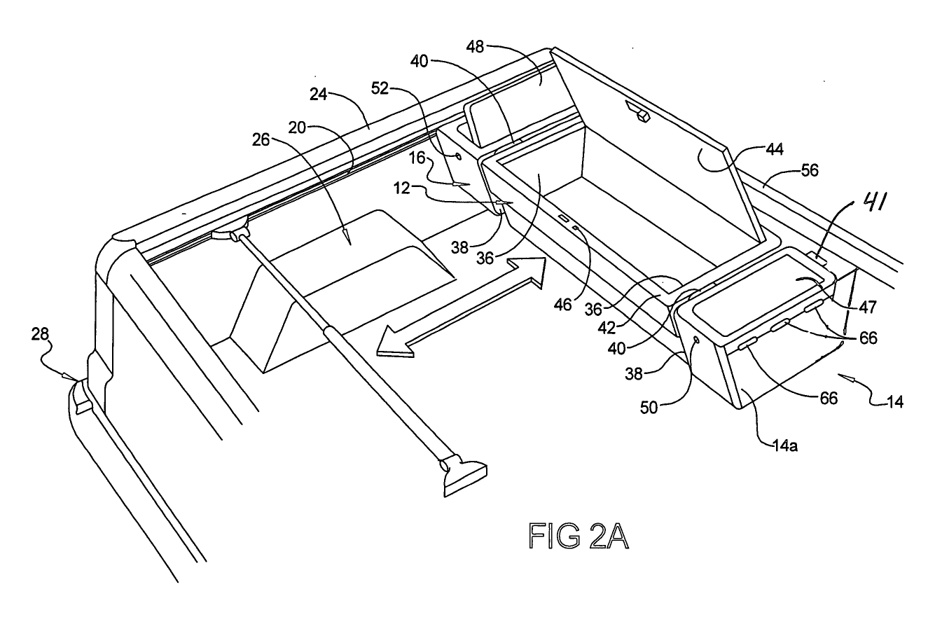

Referring to FIG. 1, there is shown a cargo management system 10 in accordance with an embodiment of the present disclosure. The cargo management system 10 includes a central frame portion 12 and a pair of auxiliary storage compartments 14 and 16. The entire assembly of frame portion 12 and storage compartments 14 and 16 is supported from a pair of side rails 18 and 20. The side rails, in turn, are supported on the insides of side walls 22 and 24 of a bed 26 of a pickup truck 28. In FIG. 1, a removable rigid storage tray 30 can be supported by the central frame portion 12. Referring to FIG. 2, in place of the rigid storage tray 30, a drop-in soft storage bag 32 can be used. The central frame portion 12 includes a rigid rim 12a on which a rigid lip portion 30a of rigid storage tray 30 can rest. Similarly, drop-in collapsible storage container 32 has a rigid rim portion 32a that rests on lip portion 12a. The rigid storage tray 30 is preferably made from a high strength plastic, as is the rigid rim portion 32a of collapsible storage container 32.

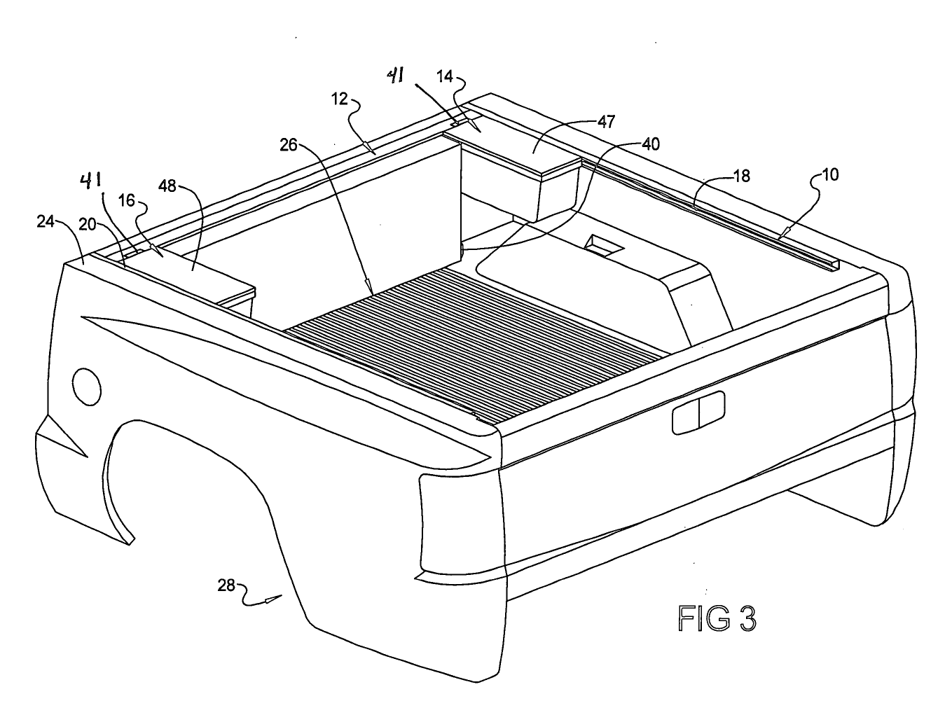

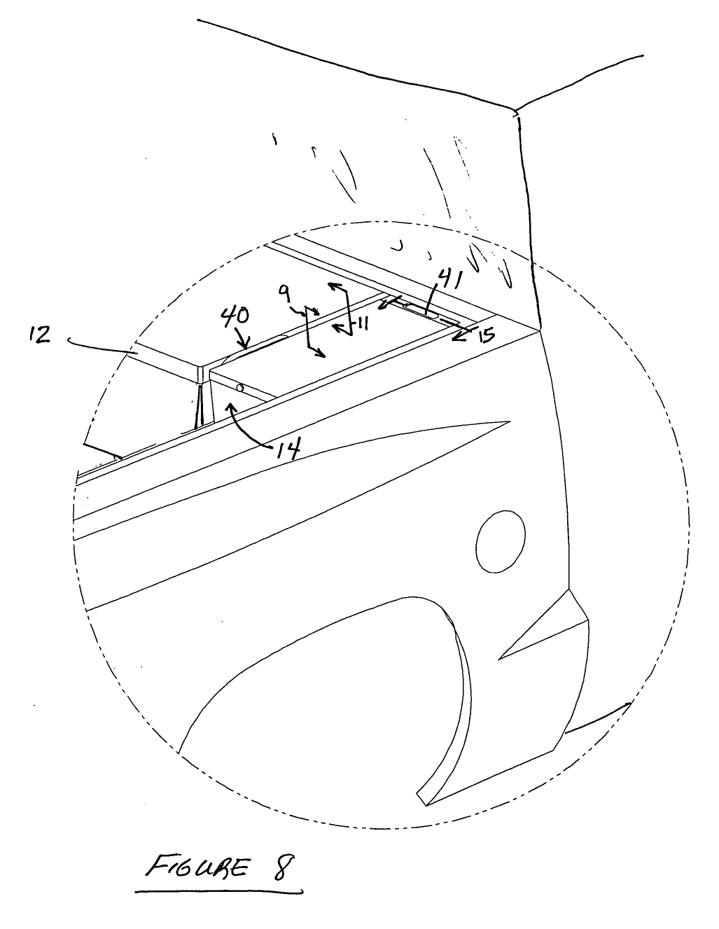

In FIGS. 1-3, the central frame portion 12 and the auxiliary storage compartments 14 and 16 are intercoupled by a pivot rod 34 (FIG. 1) that extends through wall portions 36 of the central frame portion 12 and adjacent wall portions 38 (see also FIG. 2A) of each of the auxiliary storage compartments 14 and 16, and into engagement with the side rails 18 and 20 so as to be non-removable from the side rails. A pair of release mechanisms 40 (FIG. 2A) are integrated into the central frame portion 12 to uncouple the forward portion 42 of the central frame portion 12 from the auxiliary storage compartments 14 and 16, thus allowing the entire central frame portion 12 to be pivoted downwardly into the position shown in FIG. 3. The construction of each release mechanism 40 will be described further in connection with FIGS. 8-15. Also, a pair of securing mechanisms 41 (visible in FIGS. 2a and 3) are associated with the auxiliary storage compartments 14 and 16. The securing mechanisms 41 allow the entire frame portion 12 to be adjustably positioned, and secured, at a desired longitudinal position along the side rails 18 and 20. The construction of one of the securing mechanisms 41 will also be described in greater detail in the following paragraphs.

Referring to FIGS. 2 and 2A the central frame portion 12 also includes an associated lid 44 and a lock 46 that can be used to secure the lid in its lowered position to lockably store items held in either the rigid storage tray 30 or the drop-in soft storage bag 32. Each of the auxiliary storage compartments 14 and 16 includes an associated pivotally mounted lid 47 and 48, respectively, that enables articles to be locked in the compartments 14 and 16 via locks 50 and 52.

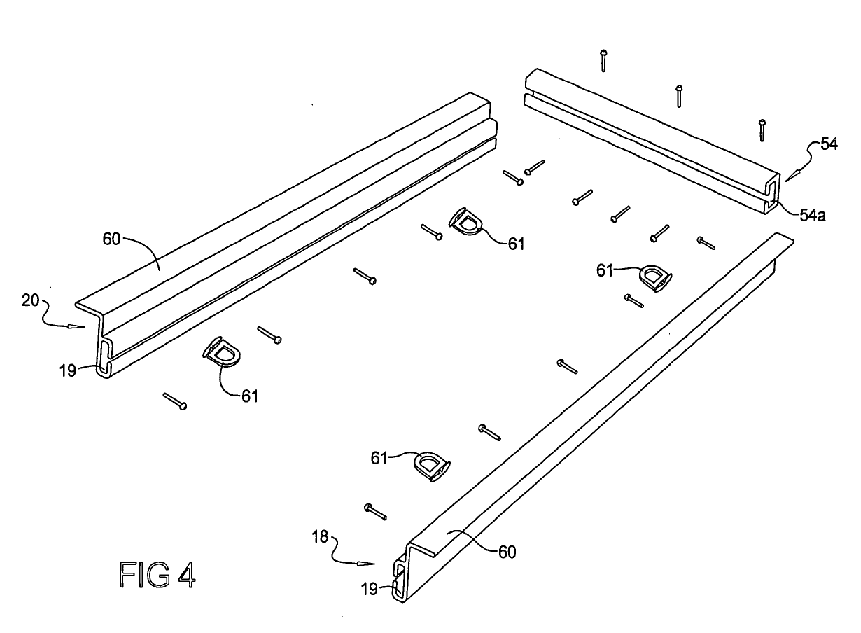

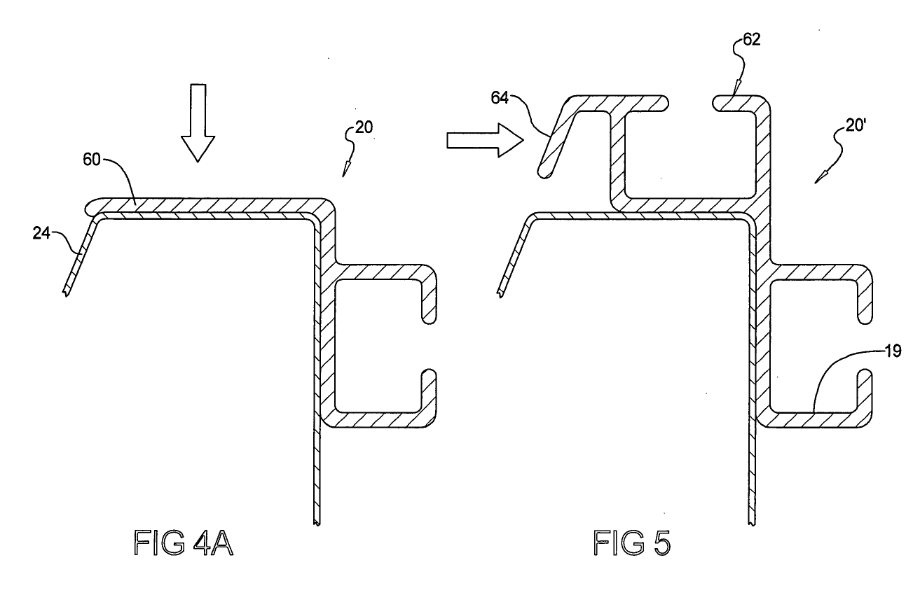

Referring to FIG. 4, the side rails 18 and 20 for supporting the central frame portion 12 and the auxiliary storage compartments 14 and 16 are shown. The side rails 18 and 20 have a C-shaped channel 19 when viewed from the end. Adjustable tie down loop assemblies 61 can also be coupled to the C-shaped channels 19 to help secure other cargo items within the bed 26. An additional side rail 54, also having a C-shaped channel 54a, is positioned against an end wall 56 (FIG. 2A) of the bed 26. The side rail 54 can be used to support adjustably positionable tie down loops (not shown). However, it will be appreciated that any tie down loops positioned in the C-shaped channel 54a may need to be removed when the central frame portion 12 and the auxiliary support compartments 14 and 16 are positioned against the end wall 56 of the bed 26.

With further reference to FIGS. 4 and 4A, each side rail 18 and 20 may include a flange 60 to protect the upper edge of the side wall 22 or 24 which it rests on. With brief reference to FIG. 5, in one alternative preferred form, a second upwardly opening C-track 62 is illustrated formed on an alternative preferred side rail 20′. Track 62 also includes a flange 64 that assists in holding a tonneau cover over the pickup truck bed. Track 62 of alternative side rail 20′ may be used to support a load bearing cross member for adjustable positioning along the bed 26. Any form of threaded member that includes a tap plate that slides within the track 62, in conventional fashion, can be used to secure the cross bar at a desired position along a pair of the side rails 20′.

The cargo management system 10 thus can be used in connection with the rigid storage tray 30 or with the soft, drop-in, collapsible storage bag 32. Advantageously, switching from the rigid storage tray 30 to the soft drop-in cargo storage bag 32 can be done without any tools and without complicated disassembly procedures. If needed, when the drop-in storage bag 32 is installed, the entire central frame portion 12 can be lowered flush against the end wall of the pickup truck bed 26, as shown in FIG. 3.

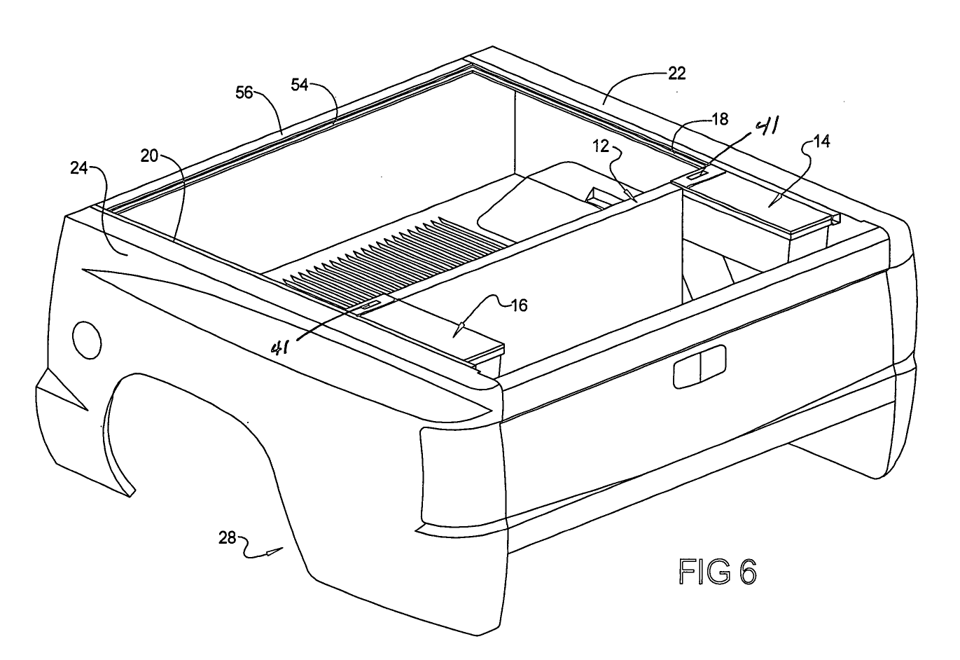

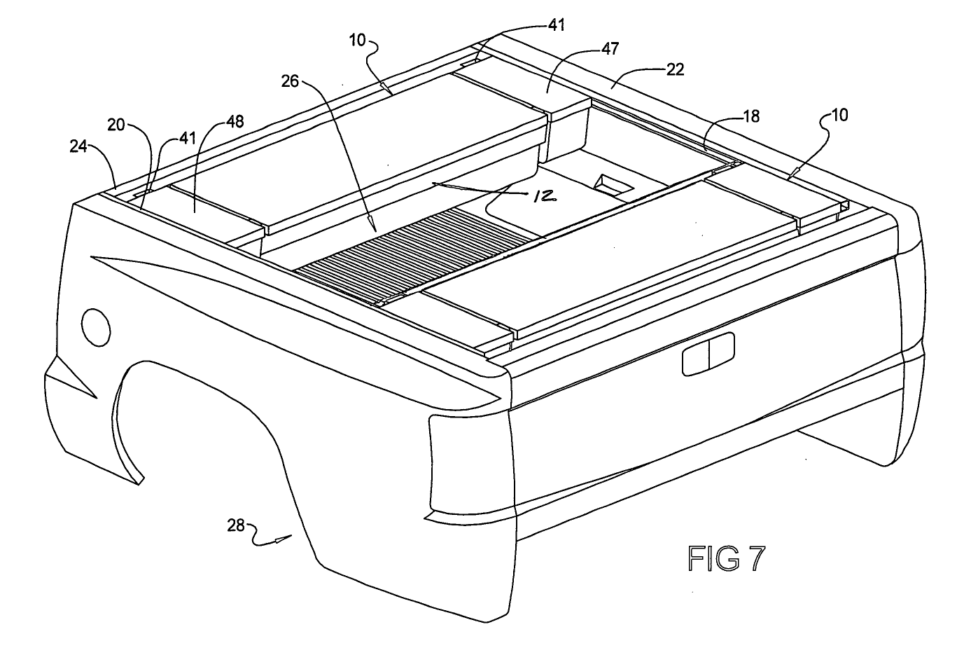

Furthermore, the entire central frame portion 12 and auxiliary cargo storage compartments 14 and 16 can be moved slidably as a single unit along the side rails 18 and 20 and secured, using the securing mechanisms 41, at a desired position within the bed 26 as needed. This allows the system 10 to be used as a bulkhead to restrain other cargo items being transported in the pickup bed 26, as indicted in FIG. 6. The system 10 is shown in FIG. 7 in two different locations in the pickup bed 26 while in its useable orientation. The auxiliary cargo storage compartments 14 and 16 have a limited depth that does not interfere with the wheel wells within the pickup bed 26. Accordingly, the compartments 14 and 16 can be moved freely along the side walls 22 and 24 without interfering with the wheel wells.

With reference to FIG. 2A, the auxiliary cargo storage compartments 14 and 16 may each be supported by a plurality of T-lug shaped projections 66 on a portion of its respective sidewall 22 or 24, T-lug portions 66 engage within the C-shaped channel 19 of its associated side rail 18 or 20 to allow sliding movement therealong. It will be appreciated that separate components with manually engageable locking wheels could be secured to the outside wall portion 14a (FIG. 2a) of the auxiliary cargo supporting compartment 14 and the outside wall portion 16a of container 16, and that could include the T-shaped lug portions 66. If such separate components are used, they each could be provided with a separate manually engageable locking wheel and tap plate assembly that allows the central frame portion 12 and each of the cargo storage compartments 14 and 16 to be fixedly secured at a desired position along the side rails 18.

Referring to FIGS. 8-14, one of the release mechanisms 40 will be described in more specific detail. It will be appreciated that the release mechanisms 40, and the structure on the auxiliary storage compartments 14 and 16 that the respective mechanisms 40 cooperate with, are identical in construction. Accordingly, only the release mechanism 40 associated with auxiliary storage compartment 14 will be described in detail.

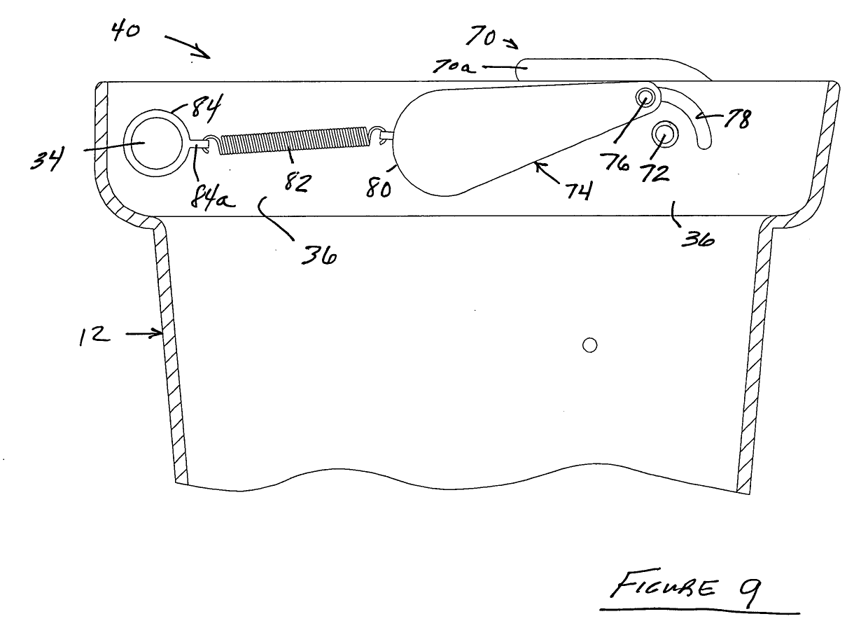

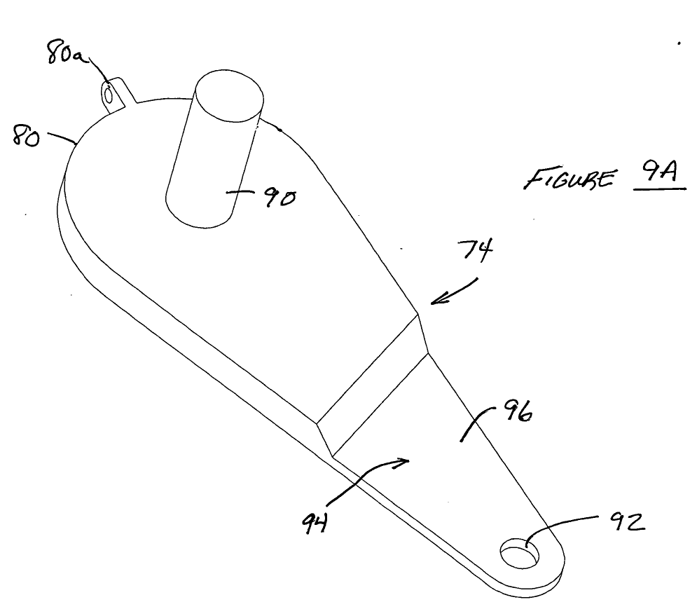

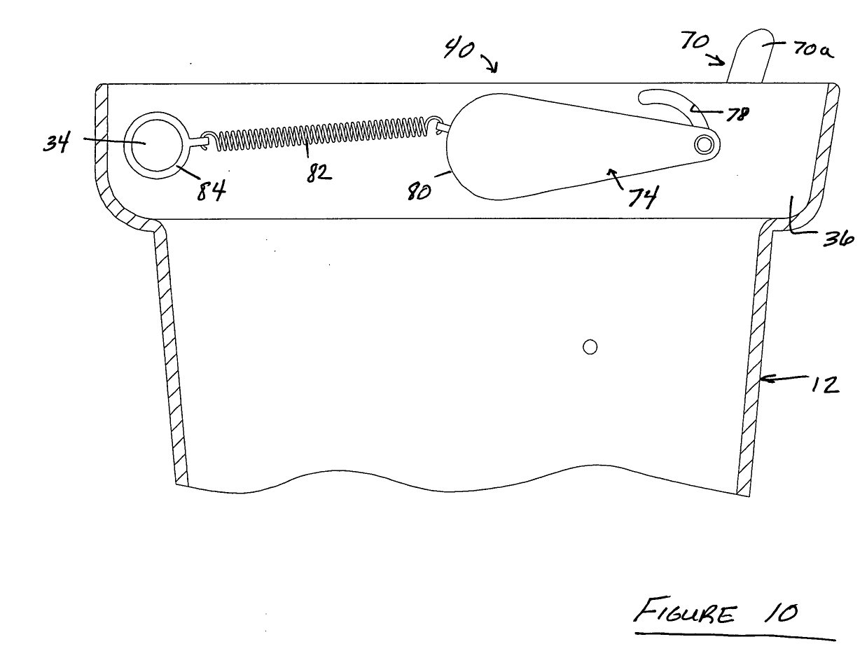

Referring specifically to FIG. 8, the release mechanism 40 includes a release lever 70 having a manually graspable handle portion 70a. The release lever 70 is positioned along one of the exterior wall portions 36 of the central frame portion 12. Referring to FIG. 9, the release lever 70 is pivotally supported by a pivot pin 72 from the frame portion 12. A coupling member 74 is secured to a projecting boss portion 76, such as by a snap ring, that protrudes from the release lever 70 (FIG. 9). The boss portion 76 is positioned to ride in an arcuate cut-out 78 in the wall portion 36 of the frame portion 12. A tang 80a at a curving rear portion 80 of the coupling member 74 is coupled via a spring 82 to a tang 84a on a securing ring 84 that is positioned over the pivot rod 34. Thus, the spring 82 biases the release lever 70 into the position shown in FIG. 9. By grasping the release lever 70 and pulling upwardly, the release lever can be pivoted into the position shown in FIG. 10.

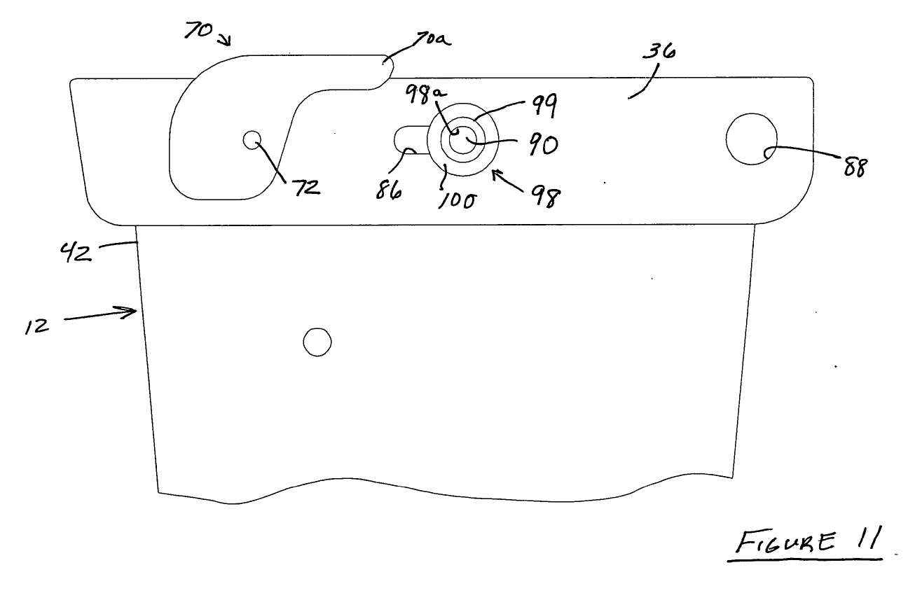

Referring to FIG. 11, the construction of the release mechanism 40 is further illustrated. The wall portion 36 also includes an elongated slot 86 and an aperture 88 through which the pivot rod 34 projects (the pivot rod 34 being omitted in this figure).

With brief reference to FIG. 9A, the coupling member 74 includes a post 90 having a length sufficient to project through the elongated slot 86 shown in FIG. 11. An aperture 92 allows coupling to the projecting boss portion 76. The coupling member 74 also includes a relief area 94 that allows surface portion 96 to clear the portion of the projecting boss portion 76 that protrudes through wall portion 36 (FIG. 9) into the interior area defined by the frame portion 12.

Referring to further to FIG. 11, secured to the post 90 of the coupling member 74 is a bushing 98 having a shoulder portion 100. The bushing 98 has a bore 98a that is press fit or otherwise secured by adhesives to the post 90 after the coupling member 74 is assembled to the frame portion 12.

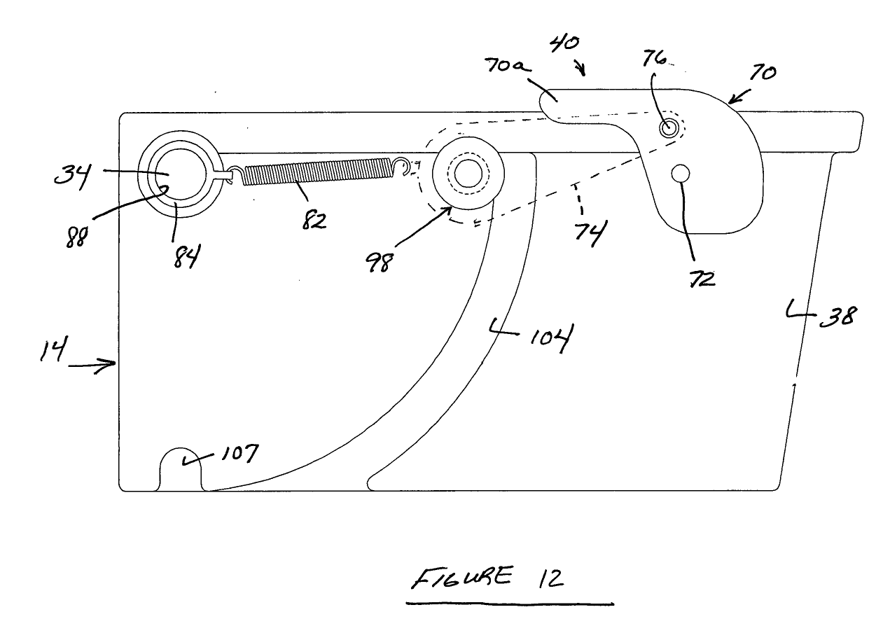

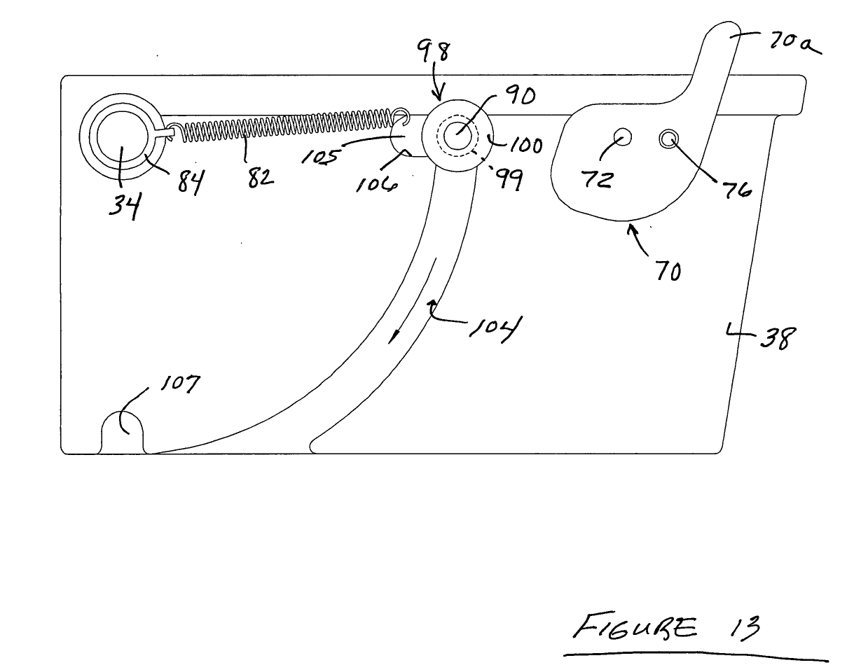

Referring to FIGS. 12 and 13, the wall portion 38 of the auxiliary storage compartment 14 includes an arcuate recess or slot 104 formed therein. The slot 104 has an upper, linear portion 105 having a ledge 106 (FIG. 13), and a recess 107 in a lower wall portion adjacent an opening of the slot 104. The portion 105 has a width sufficient to accept a head portion 99 (FIG. 11) of the bushing 98. When the release lever 70 is in the closed position, as shown in FIG. 12, the head portion 99 rests on the ledge 106 within portion 105. This supports the entire frame portion 12 in its upright or usable position. The spring 82 functions to bias the coupling member 74 into the position shown in FIGS. 9 and 12 so that the frame portion 12 is held securely in this position during normal use.

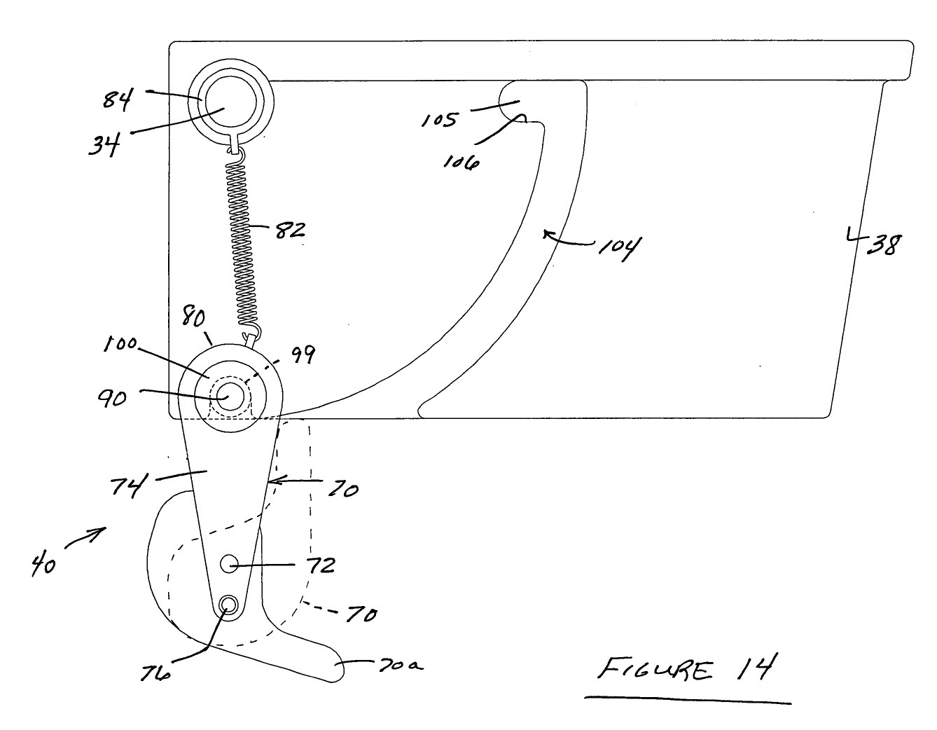

When the user desires to lower the frame portion 12, the rigid storage tray 30 is removed (unless the soft, drop-in storage container 32 is present in the frame portion 12), and the handle portion 70a of the release lever 70 is lifted into the position shown in FIGS. 10 and 13. This causes the coupling member 74 to be urged away from the pivot rod 34 against the biasing force of spring 82. As the release lever 70 is pivoted clockwise in the drawing of FIG. 13, the bushing 98 moves forwardly in the elongated slot 86 (FIG. 11), relative to the forward portion 42 of the frame portion 12. When the release lever 70 is fully opened, the head portion 99 of the bushing 98 will be positioned as shown in FIG. 13, and will thereafter be free to move downwardly in the arcuate slot 104. The frame portion 12 can then be lowered, which causes the bushing 98 to ride in the slot 104 until the frame portion 12 is in the fully lowered position (FIG. 14). Once the head portion 99 reaches the recess 107, the biasing force provided by spring 82 causes the head portion 99 to snap upwardly into the recess 107. As this action occurs, the release lever 70 is rotated back into a closed position by the spring 82, as indicated in phantom in FIG. 14. The securing ring 84 is free to rotate on the pivot rod 34, so the biasing force provided by the spring 82 is now directed along a substantially vertical axis in FIG. 14. This serves to maintain the frame portion 12 locked in its lowered (i.e., stowed) position, and also to prevent movement or swinging of the frame portion 12 about the pivot rod 34 while the vehicle is moving. It will be appreciated that the above-described operation for actuating the release mechanism 40 is performed simultaneously for both release mechanisms 40 when the frame portion 12 is to be lowered. If a single sided release feature is desired, then a torque rod could be fixedly coupled to each of the release levers 70. This would allow both of the release levers 70 to be rotated simultaneously by simply grasping and rotating either release lever 70. The torque tube could be positioned adjacent a forward edge of the frame portion 12 so as not to interfere with removal of either the rigid stowage tray 30 or the collapsible storage bay 32.

Releasing the coupling member 74 from the position shown in FIG. 14 simply involves the user pulling downwardly on the handle portion 70a of the release lever 70, which moves the head portion 99 of the bushing 98 downwardly out of the recess 107, and while holding the release lever 70 in this position, lifting the entire frame portion 12 upwardly. Once the head portion 99 enters the arcuate portion of the slot 104 the handle portion 70a of the release lever 70 can be released. When the head portion 99 reaches the ledge portion 106, the biasing force of spring 82 causes the head portion 99 to be pulled into the portion 105. At this point the biasing force will also automatically rotate the release lever to the closed position as shown in FIG. 12. The head portion 99 will then be located in recess 105 and supported on the ledge portion 106 of slot 104, which supports the entire frame portion 12 in its usable orientation. Again, this operational sequence is performed simultaneously at both release mechanisms 40 when the frame portion 12 is to be lifted into its operative position.

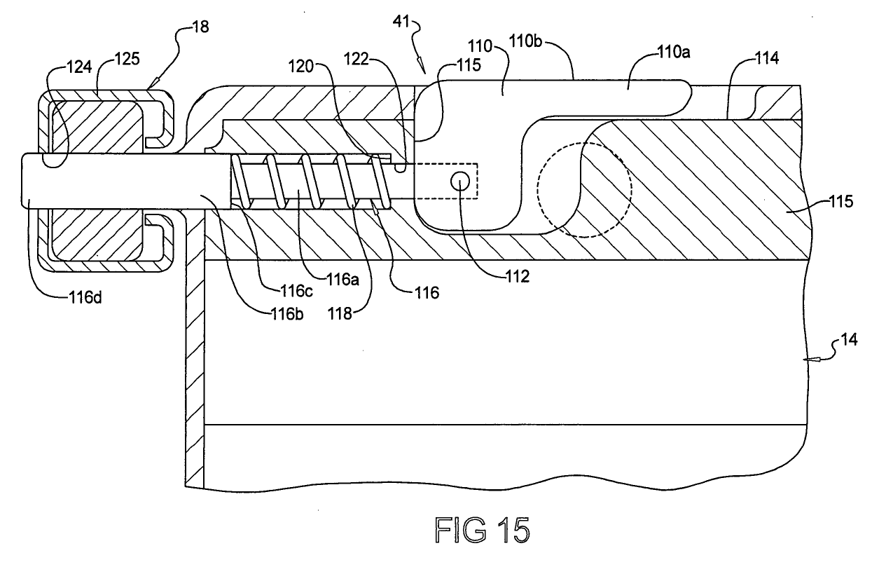

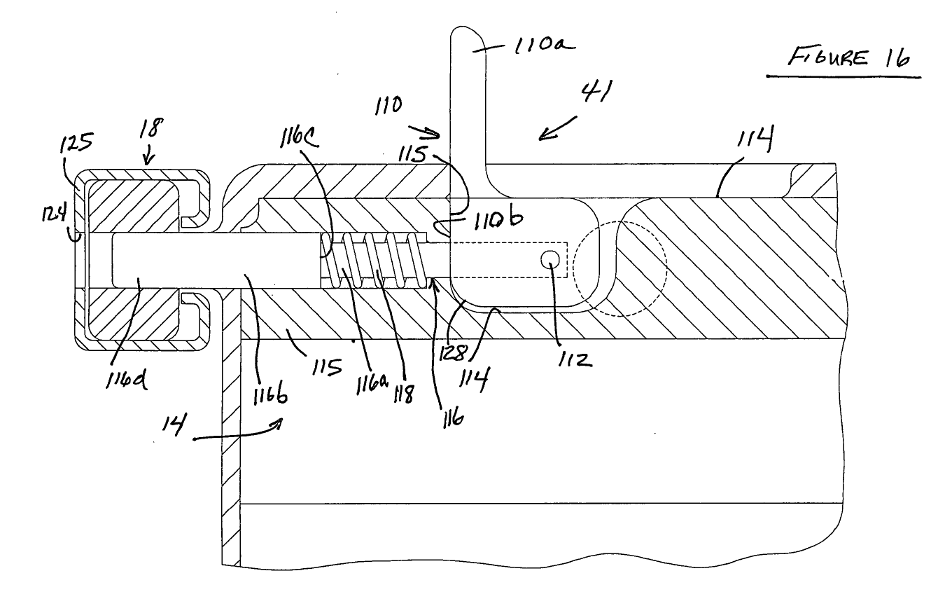

Referring to FIGS. 15 and 16, the securing mechanism 41 for securing the frame portion 12 at a desired longitudinal position along the side rails 18 is shown. It will be appreciated that the construction and operation of securing mechanism 41 that cooperates with side rail 20 is identical in construction to the mechanism associated with side rail 18.

In FIG. 15, the securing mechanism 41 includes a pivotally mounted locking lever 110 that is movable from a locked position, as shown in FIG. 15, to an open position (i.e., unlocked) as shown in FIG. 16. The locking lever 110 is secured to a pivot pin 112 and located within a complementarily shaped recess 114 in a wall portion 115 of the auxiliary storage compartment 14. The locking lever 110 includes a handle portion 110a that is manually graspable to enable it to be easily lifted with a thumb or forefinger. The pivot pin 112 secures the locking lever 110 to a circumferential locking pin 116 having a first portion 116a that is smaller in diameter than a second portion 116b, thus creating a circumferential shoulder 116c. A spring 118 is positioned over the first portion 116a so that one end abuts the shoulder 116c and the opposite end abuts a wall surface 120 within the compartment 14. The wall surface 120 is in communication with a bore 122 through which the locking pin 116 extends. End 116d of the locking pin 116 is dimensioned to be able to engage within one of a plurality of spaced apart apertures 124 in the side rail 18. The spring 118 provides a constant biasing force that tends to urge the end 116d of the locking pin 116 towards a wall portion 125 of the side rail 18 in which the apertures 124 are present.

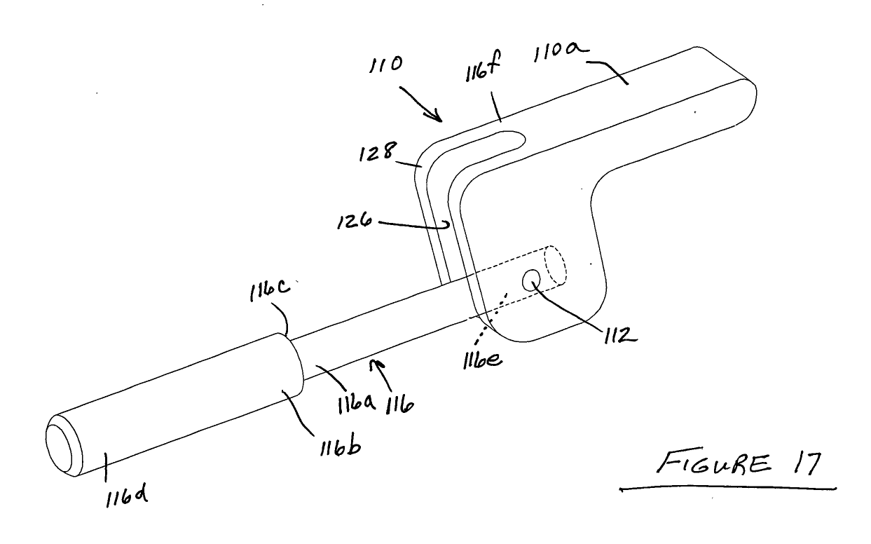

Referring to FIG. 17, an end 116e of the locking pin 116 extends through a yoke portion 126 of the locking lever 110. Yoke portion 126 provides the needed clearance for end 116e when the locking lever 110 is moved between its locked position (FIG. 15) and its unlocked position (FIG. 16). The end 116e is secured to the locking lever 110 by the pivot pin 112. The locking lever 110 also includes a camming surface 128 which enables the lever 110 to move smoothly over an interior wall surface 115 of the recess 114 in which the locking lever 110 is located.

When the system 10 is to be moved to a new longitudinal position within the pick-up bed 26, the user simply lifts up on the handle portion 110a of each securing mechanism 41 until each is in the position shown in FIG. 16. This rotation of the locking lever 110 causes the camming surface 128 to withdraw the locking pin 116 (i.e., move the locking pin 116 to the right in the drawing of FIG. 16) against the force of the spring 118. A linear portion 110b of the locking lever 110 enables the locking lever 110 to be held in the unlocked position by the biasing force from the spring 118. At this point, the entire frame portion 12 can be moved slidably along the side rails 18 and 20 to a new position, and the locking lever 110 of each securing mechanism 41 then urged back into the locked position shown in FIG. 15.

The system 10 thus provides a convenient means for storing articles within a bed of a vehicle. The system 10 also is able to function as a bulkhead to restrain larger articles that are being carried in the bed adjacent the system 10. The system 10 can be completely removed from, or positioned at a desired location within, the bed of a motor vehicle to maximize the utility of the bed.

The description of the system and method is merely exemplary in nature and, thus, variations that do not depart from the gist of the present disclosure are intended to be within the scope of the appended claims. Such variations are not to be regarded as a departure from the spirit and scope of the present disclosure.

What is claimed is:

1. A cargo management system for a bed of a motor vehicle, comprising:
a pair of side rails secured to oppositely facing sidewalls of the bed of the vehicle;
a frame portion supported from the side rails for movement and adjustable positioning along the side rails; and
at least one storage compartment supported by the frame.

2. The system of claim 1, wherein said frame portion is pivotally supported relative to the side rails and movable pivotally from a useable position to a stored position parallel to an end wall of said bed of said vehicle.

3. The system of claim 1, further comprising at least one auxiliary storage compartment located adjacent to said at least one storage compartment, and movable along said side rails together with said at least one storage compartment.

4. The system of claim 1, wherein said at least one storage compartment comprises a rigid tray.

5. The system of claim 4, wherein said rigid tray is removable from said frame portion.

6. The system of claim 4, wherein said at least one storage compartment comprises a flexible material.

7. The system of claim 3, wherein said frame portion is supported from said auxiliary storage compartment and moveable independently pivotally relative to said auxiliary storage compartment.

8. A cargo management system for a bed of a motor vehicle, comprising:
a pair of side rails secured to oppositely facing sidewalls of the bed of the motor vehicle;
a frame portion;
a first storage compartment supported from said frame portion;
second and third storage compartments located on opposite sides of said first storage compartment and supporting said first storage compartment;
said second and third storage compartments each being supported from a respective one of said side rails for sliding movement along its respective said side rail, such that said first, second and third storage compartments can be moved as a single assembly; and
said frame portion being pivotally supported relative to said second and third storage compartments to be movable from a useable position to a stowed position.

9. The system of claim 8, wherein said first storage compartment comprises a rigid tray.

10. The system of claim 8, wherein said first storage compartment comprises a non-rigid fabric storage bag.

11. The system of claim 8, wherein said first storage compartment is removable from said frame portion.

12. The system of claim 8, wherein said first, second and third storage compartments can be positioned along said side rails at a desired point within said bed, and secured thereat to enable said system to operate as a bulkhead within said bed.

13. A cargo management system for a bed of a motor vehicle, comprising:
a pair of side rails secured to oppositely facing sidewalls of the bed of the motor vehicle;
a frame portion;
a first storage compartment removably supported from said frame portion;
second and third storage compartments located on opposite sides of said first storage compartment and supporting said first storage compartment;
said second and third storage compartments each being supported from a respective one of said side rails for sliding movement along its respective said side rail, such that said first, second and third storage compartments can be moved as a single assembly;
said second and third storage components each including a securing mechanism for securing it against longitudinal movement on its associated side rail; and
said frame portion being pivotally supported relative to said second and third storage compartments to be movable from a useable position to a stowed position.

14. The system of claim 13, wherein each said side rail includes a C-shaped channel portion for engaging with structure associated with its associated said second or third storage compartment.

15. The system of claim 13, wherein each said side rail includes:
a first channel for engaging with structure associated with its associated said second or third storage compartment; and
a second channel extending co-extensively with said first channel for supporting one end of a cross bar thereon.

16. The system of claim 13, wherein said first storage compartment comprises a rigid tray.

17. The system of claim 13, wherein said first storage compartment comprises a non-rigid fabric storage bag.

18. The system of claim 13, wherein said first storage compartment includes a cover member that is lockable independently of said second and third storage compartments.

19. The system of claim 13, wherein said first storage compartment comprises a release assembly for releasing said first storage compartment to enable it to move pivotally relative to said second and third storage compartments, into said stowed position
